(19) United States
(12) Patent Application Publication
(10) Pub. No.: US 2014/0354007 A1
(43) Pub. Date: Dec. 4, 2014

(54) VEHICLE DOOR

(71) Applicant: HONDA MOTOR CO., LTD., Tokyo (JP)

(72) Inventors: Masayuki Ogawa, Wako-shi (JP); Eiji Hirano, Wako-shi (JP); Kiyohito Kurokawa, Wako-shi (JP); Ryuichi Murai, Wako-shi (JP); Takenobu Haga, Wako-shi (JP); Hakurei Watanabe, Wako-shi (JP)

(73) Assignee: HONDA MOTOR CO., LTD., Tokyo (JP)

(21) Appl. No.: 14/368,836

(22) PCT Filed: Dec. 20, 2012
(86) PCT No.: PCT/JP2012/083087

§ 371 Date: Jun. 26, 2014

(30) Foreign Application Priority Data
Dec. 28, 2011 (JP) 2011-287720

(51) Int. Cl. B60J 5/04

(52) U.S. Cl. CPC B60J 5/0402
USPC 296/146.2

(57) ABSTRACT

A vehicle door includes a latch mechanism that is installed on the door body and is engaged with an engaging member, which is positioned on a vehicle body, when the door is closed, a rod member that connects the door outer handle and the latch mechanism such that the door outer handle operates simultaneously with and the latch mechanism, and a counterweight that is provided in the door outer handle and is disposed at a position at which the counterweight directly faces the sash member, at an outer side of the sash member in an in-out direction of the vehicle, and the counterweight transmitting an inertia force of the counterweight, which acts when an impact load applied from an outside of the vehicle is inputted, to the rod member as a load in a latch maintaining direction.

### BACKGROUND OF THE INVENTION

1. Field of the Invention

The present invention relates to a vehicle door having a latch mechanism which operates simultaneously with a door outer handle.

Priority is claimed on Japanese Patent Application No. 2011-287720, filed on Dec. 28, 2011, the content of which is incorporated herein by reference.

2. Description of Related Art

In most vehicle doors, a door outer handle is provided on a vehicle outer side surface of a door body and the vehicle doors have a structure in which the door outer handle operates simultaneously with a latch mechanism which is engaged with a striker (an engaging member) provided on a door opening side of a vehicle body.

In this type of vehicle door, it is important that, when an impact load applied from a vehicle outer side is inputted, the latch mechanism is prevented from being released by an unexpected force. Accordingly, various improvements have been made (for example, see PTL 1).

In a vehicle door disclosed in PTL 1, a lever portion which allows a grip of the door outer handle to operate simultaneously with a latch mechanism is pivotally provided in a door body. In addition, a lock cam which faces the lever portion in an in-out direction of a vehicle body is installed on a sash member which guides upward and downward movement of a door glass. The lock cam is configured such that, when the door body is deformed in a vehicle inner direction when an impact load applied from a vehicle outer side is inputted, and thus the lever portion is displaced in a vehicle interior direction, the lock cam comes into contact with the lever portion to limit the rotation of the lever portion in a latch releasing direction.

### CITATION LIST

### Patent Literature

[PTL 1] Microfilm of Japanese Utility Model Application No. H1-95631 (Japanese Unexamined Utility Model Application, First Publication No. H3-35168)

### SUMMARY OF THE INVENTION

### Technical Problem

However, in the vehicle door of the related art, it is necessary to install a dedicated lock cam, which limits the release of the latch mechanism when the impact load is inputted, on the sash member. Thus, the number of components is increased and a structure is complicated. Therefore, there is a concern that this leads to an increase in product costs.

Furthermore, in the vehicle door of the related art, it is difficult to perform an installation adjustment of the lock cam to cause the lever portion to reliably cone into contact with the lock cam when the impact load is inputted. Thus, improvement in this regard is also required.

For this reason, the invention provides a vehicle door which can reliably limit release of a latch mechanism when an impact load is inputted, without causing an increase in the number of components or a complicated structure.

### Solution to Problem

To solve the problems described above, the vehicle door according to the invention is configured as follows.

A vehicle door according to an aspect of the invention includes a door body inside which a hollow portion is formed, a door glass which is upward and downward movably held to an upper portion of the door body, a sash member which is disposed in the hollow portion of the door body and guides the upward and downward movement of the door glass, a door outer handle which has a grip to be gripped by an operator of a door, is provided on a vehicle outer side surface of the door body, and is operable to move forward or rearward, a latch mechanism which is installed on the door body and is engaged with an engaging member, which is positioned on a vehicle body side of the vehicle when the door is closed, a rod member which connects the door outer handle and the latch mechanism such that the door outer handle operates simultaneously with the latch mechanism, and a counterweight which is provided in the door outer handle and is disposed at a position at which the counterweight directly faces the sash member, at an outer side of the sash member in an in-out direction of the vehicle, and the counterweight transmitting an inertial force of the counterweight, which acts when an impact load applied from an outside of the vehicle is inputted, to the rod member as a load in a latch maintaining direction.

In this case, when the impact load is inputted to the door body from outside of the vehicle, the inertia force acting on the counterweight of the door outer handle is applied to the rod member as the load in the latch maintaining direction. Furthermore, the door outer handle is displaced in the vehicle interior direction with the deformation of the door body. Subsequently, when the door outer handle is displaced in the vehicle interior direction by a distance equal to or greater than the predetermined distance, the counterweight comes into contact with the sash member and is engaged with the sash member. Therefore, release of the latch mechanism via the rod member is limited.

In the vehicle door according an aspect of the invention, it is preferable that the rod member be directly connected to the counterweight.

In the vehicle door according to still another aspect of the invention, it is preferable that the door outer handle further include a base block which is fixed to the door body and a lever portion which is pivotally supported to the base block by a pivot shaft which extends in a direction perpendicular to the in-out direction of the vehicle, and that the lever portion have a first arm and a second arm which are arranged to sandwich the pivot shaft, in which the grip is engaged with the first arm such that the grip operates simultaneously with the first arm, and the rod member is engaged with the second arm such that the rod member operates simultaneously with the second arm. In addition, it is preferable that the counterweight extend from the second arm in a substantially horizontal direction.

In this case, the counterweight extends in a direction substantially perpendicular to the sash member.

In the vehicle door according to an aspect of the invention, it is preferable that an end of the rod member be inserted into the counterweight, along an extension direction of the counterweight.

In the vehicle door according to an aspect of the invention, it is preferable that the counterweight include a protrusion which extends in a direction in which the protrusion faces the sash member.

In this case, when the impact load is inputted to the door body from the outside of the vehicle, and thus the door outer handle is displaced in a vehicle interior direction, the protrusion of the counterweight comes into contact with the sash member. Accordingly, it is possible to more reliably deform the sash member.

In the vehicle door according to an aspect of the invention, it is preferable that the sash member include an upper sash having a lower end, the lower end being disposed in the hollow portion of the door body, a lower sash that is separated from the upper sash and disposed in the hollow portion of the door body so as to be continuous with the upper sash, and a connecting bracket that is installed on an upper end of the lower sash and covers a periphery of the upper sash with a gap interposed between the upper sash and the connecting bracket, and that the counterweight comes into contact with the connecting bracket when the impact load applied from the outside of the vehicle is inputted.

In this case, when the impact load is inputted to the door body from the outside of the vehicle, and thus the door outer handle is displaced to a vehicle interior, the counterweight comes into contact with the connecting bracket. Therefore, the connecting bracket is deformed. In this case, a gap is provided between the connecting bracket and the upper sash, and thus the connecting bracket, is easily deformed.

### Advantageous Effects of Invention

According to an aspect of the invention, the counterweight of the door outer handle is disposed at a position at which the counterweight directly faces the sash member, from the outer side of the sash member in an in-out direction of the vehicle. Thus, when the impact load is inputted to the door body from the outside of the vehicle, and thus the door outer handle is deformed in the vehicle interior direction by a distance equal to or greater than the predetermined distance, the counterweight comes into contact with the sash member and is engaged with the sash member. Accordingly, the release of the latch member via the rod member is reliably limited. Therefore, according to the invention, when the impact load is inputted, the release of the latch mechanism can be reliably limited, without causing installation of additional dedicated components or a complicated structure.

According to an aspect of the invention, the rod member is directly connected to the counterweight. Thus, when the impact load is inputted, the counterweight which directly comes into contact with the sash member can reliably limit the displacement of the rod member in the latch releasing direction.

According to an aspect of the invention, the counterweight extends, in the substantially horizontal direction, from the end of the lever portion which pivots on the pivot shaft perpendicular to the in-out direction of the vehicle. Thus, the counterweight extends in a direction substantially perpendicular to the sash member. Accordingly, when the impact load is inputted, the counterweight can always reliably comes into contact with the sash member even when the door body is deformed in various ways.

According to an aspect of the invention, the end of the rod member is inserted into the counterweight along the extension direction of the counterweight. Thus, a sufficient length of the end the rod member can be stably engaged with the counterweight. Accordingly, the rod member can be stably operated in normal use. In addition, the unexpected release of the latch mechanism can be reliably limited, through the rod member, when the impact load is inputted.

According to an aspect of the invention, when the impact load is inputted to the door body from the outside of the vehicle, and thus the door outer handle is displaced to the vehicle interior, the protrusion portion of the counterweight comes into contact with the sash member. Thus, the protrusion portion easily and reliably deforms the sash member. Accordingly, unexpected release of a latching member via the rod member can be reliably limited.

According to an aspect of the invention, the gap is provided between the connecting bracket which is installed on the upper end of the lower sash of the sash member and the periphery of the upper sash. Therefore, when the impact load is inputted to the door body from the outside of the vehicle, the counterweight comes into contact with the connecting bracket, and thus the connecting bracket of the sash member can be easily deformed. Accordingly, the displacement of the rod member in the latch releasing direction can be more reliably limited.

According to an aspect of the invention, when the impact load is inputted, the counterweight comes into contact with the connecting bracket which does not directly contribute to guide upward and downward movement of the door glass. Thus, performance for guiding the upward and downward movement of the door glass is prevented from being deteriorated even when the rigidity of the connecting bracket is set to be low.

### BRIEF DESCRIPTION OF THE DRAWINGS

FIG. 1 is a front view which illustrates a vehicle door according to an embodiment of the invention and a side shape of a vehicle.

FIG. 2 is a front view which illustrates a door outer handle according to the embodiment of the invention.

FIG. 3 is a back view of the door outer handle according to the embodiment of the invention.

FIG. 4 is a cross-sectional view of the door outer handle according to the embodiment of the invention, corresponding to an A-A cross-sectional surface in FIG. 3.

FIG. 5 is a rear view which illustrates a pivoting block of the door outer handle according to the embodiment of the invention.

FIG. 6 is a side view of the pivoting block of the door outer handle according to the embodiment of the invention, when viewed from the arrow B in FIG. 5.

FIG. 7 is a side view of the pivoting block of the door outer handle according to the embodiment of the invention, when viewed from the arrow C in FIG. 5

FIG. 8 is a cross-sectional view of the door outer handle according to the embodiment of the invention when an impact load is inputted, corresponding to an A-A cross-sectional surface in FIG. 3.

### DETAILED DESCRIPTION OF THE INVENTION

Hereinafter, an embodiment of the invention will be described with reference to the accompanying drawings.

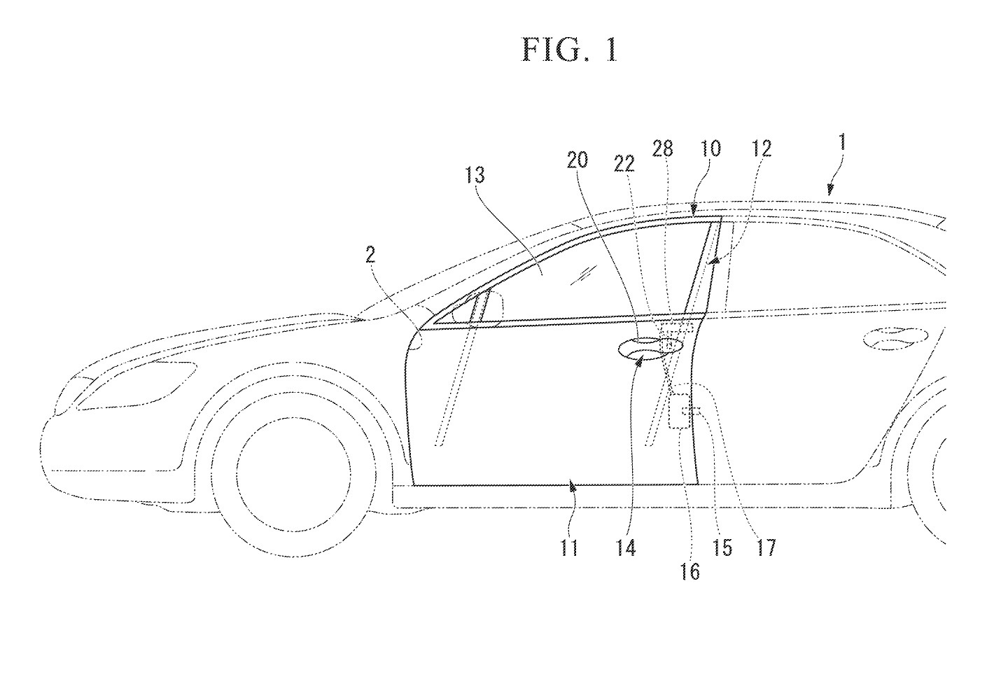

FIG. 1 is a view which illustrates a vehicle door 10 (hereinafter, referred to as a “door 10”) according to the embodiment and a side appearance of a vehicle 1. In the following description, an up-down direction and a front-rear direction mean an up-down direction and a front-rear direction of the vehicle, unless there is a particular exception.

The door 10 is installed on a door opening 2 of a vehicle body in a state where the door 10 can be opened or closed. The door 10 includes
a door body 11 having a hollow portion formed therein,
a sash member 12 which extends from an upper portion of the door body 11 to an inner portion of the door body 11,
a door glass 13 which is guided by the sash member 12 to move upward and downward, a door outer handle 14 which is provided in a rear end side area of an upper portion of a vehicle outer side surface (a door outer panel) of the door body 11 and is operable to move forward or rearward,
a latch mechanism 16 which is installed in a rear portion area in the door body 11 and which is engaged with a striker 15 (an engaging member) positioned on the vehicle body (a center pillar (not illustrated)) when the door is closed, and
a rod member 17 which connects the door outer handle 14 and latch mechanism 16 such that the door outer handle 14 operates simultaneously with the latch mechanism 16.

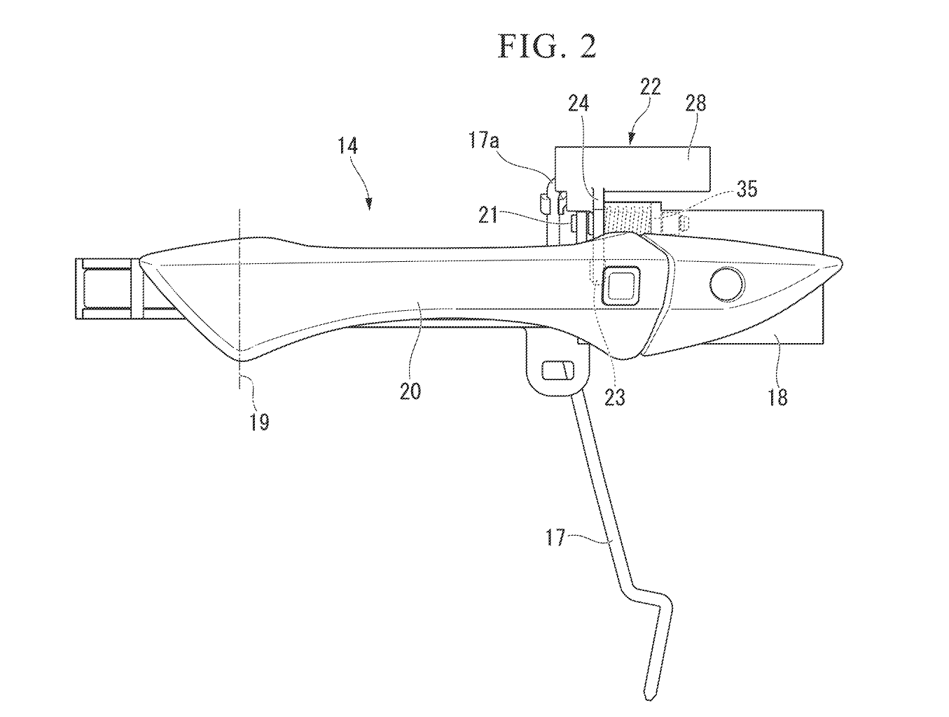

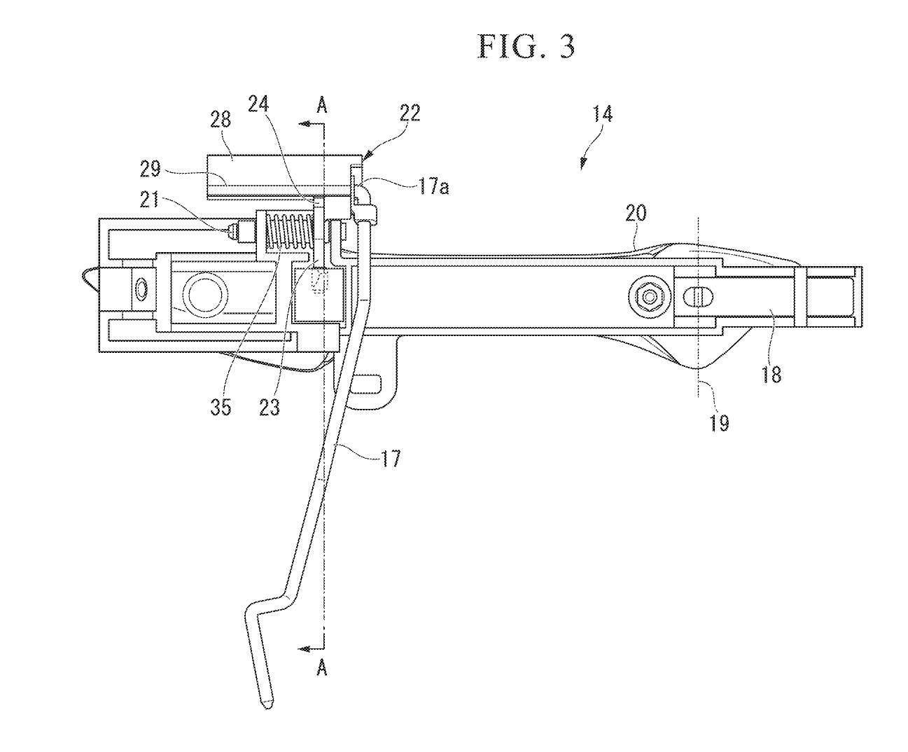

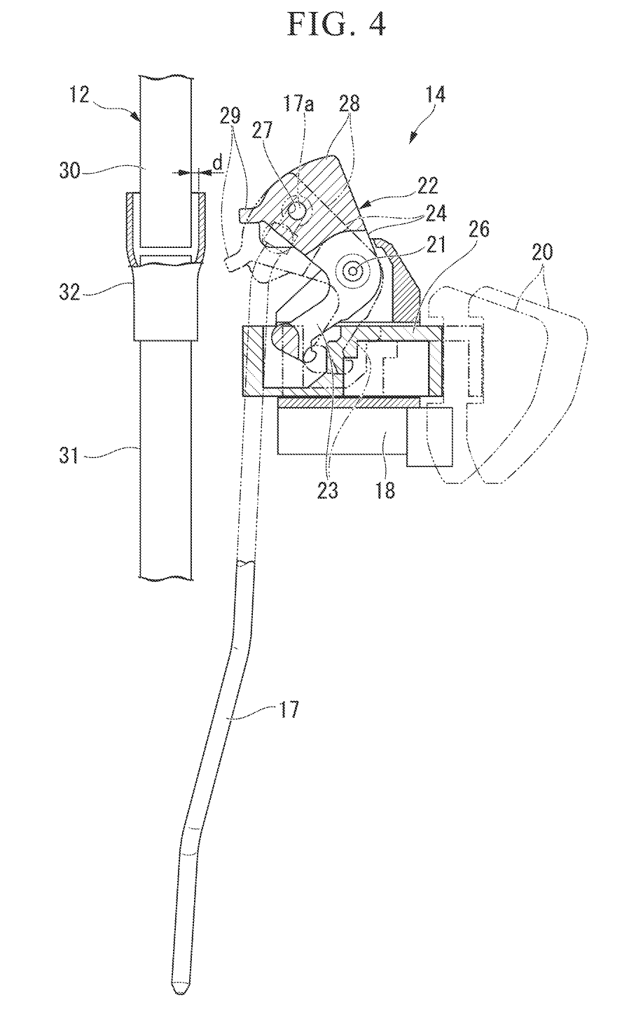

FIG. 2 is view illustrating the door outer handle 14, which is connected with the rod member 17, when viewed from a front side. FIG. 3 is a view illustrating the door outer handle 14 when viewed from a back side. FIG. 4 is a cross-sectional view corresponding to an A-A cross-sectional surface in FIG. 3.

As illustrated in these drawings, the door outer handle 14 includes a base block 18 which is installed on the door body 11 and has a shape of a horizontally long rectangular parallelepiped,
a grip 20 which is supported, via a spindle 19, to the base block 18 to be pivotable (movable forward or rearward) in a vehicle width direction and which is to be gripped by an operator of the door, and
a pivoting block 22 which is pivotally supported, via a pivot shaft 21 extending along a front-rear direction (a direction perpendicular to an in-out direction of the vehicle) of the vehicle body, to the base block 18 and which has a first arm 23 (a lever portion) that is coupled to the grip 20 and a second arm 24 (a lever portion) that is coupled to the rod member 17, respectively.

The first arm 23 and the second arm 24 are provided to pinch the pivot shaft 21. The grip 20 is engaged with the first arm 23 so that the grip section 20 operates simultaneously with the first arm 23, and the rod member 17 is engaged with the second arm 24 so that the rod member 17 operates simultaneously with the second arm 24.

A counterweight extends, from the second arm, in a substantially horizontal direction.

The reference numeral 35 in the drawings shows a return spring which is used for rotationally biasing (generating a restoring force) the pivoting block 22 in a latch releasing direction.

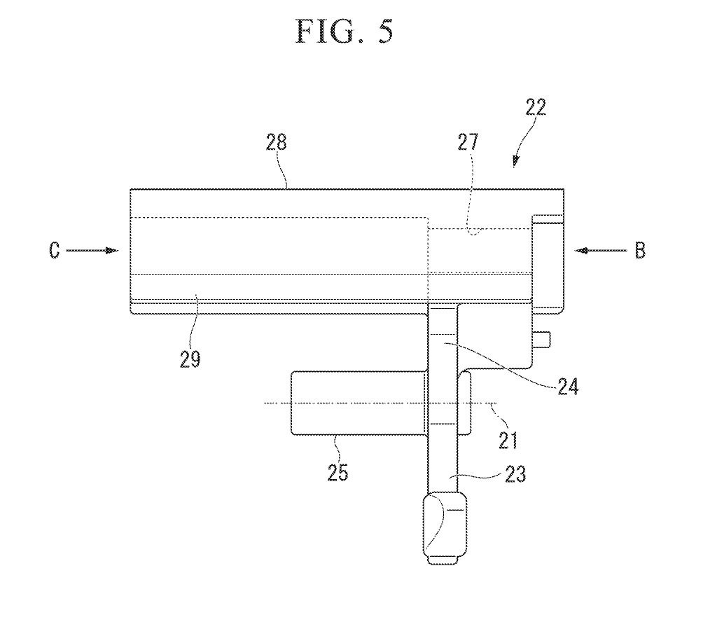

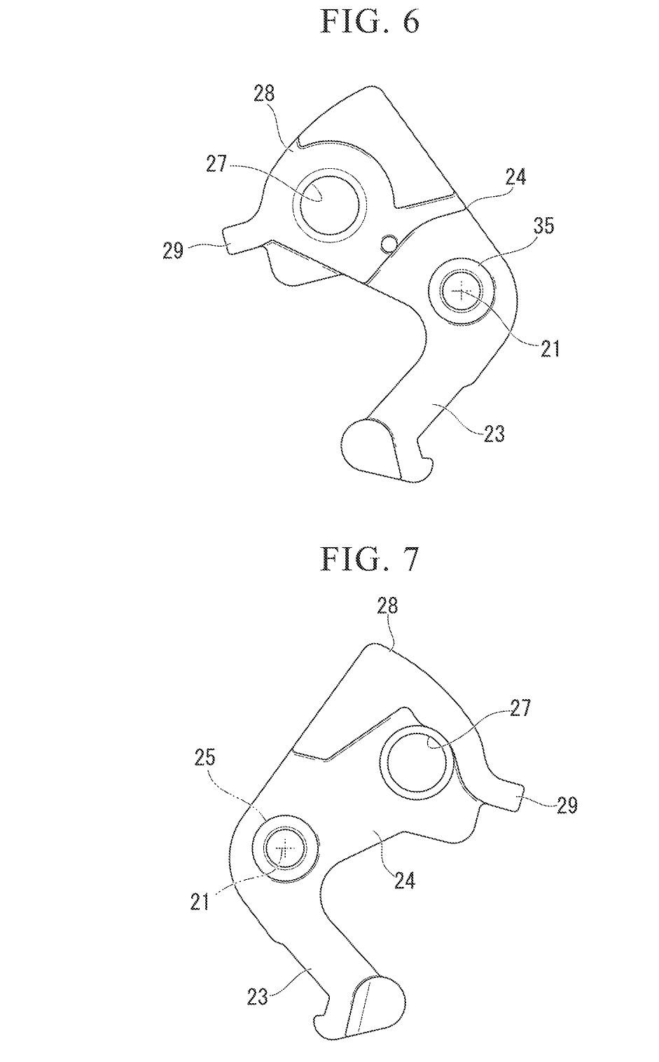

FIGS. 5 to 7 are views illustrating details of the pivoting block 22.

The pivoting block 22 is formed of a metallic material, such as lead, of which a specific gravity is greater than that of a material (mainly, resin) constituting other peripheral parts such as the grip 20, the base block 18.

The pivoting block 22 includes a cylindrical-shaped boss portion 25 into which the pivot shaft 21 which is supported by the base block 18 is inserted, as illustrated in FIGS. 5 to 7. The first arm 23 and the second arm 24 are provided on one end of the boss portion 25. The first arm 23 and the second arm 24 extend from one end of the boss portion 25 so that the first arm 23 and the second arm 24 are disposed at approximately 90° in a planar surface perpendicular to an axis direction of the boss portion 25. The entirety of the first arm 23 and the second arm 24 has a substantially L shape.

A tip end of the first arm 23 is engaged with a slide block 26 which is held by the base block 18 to be slidable in the vehicle width direction and which is operated simultaneously with the grip 20. Therefore, a forward or rearward movement operation (a pivoting operation) of the grip 20 is converted, by the slide block 26, into a rotation movement of the pivoting block 22.

In addition, a counterweight 28 is integrally formed on a tip end of the second arm 24. An engaging hole 27 into which a bent portion 17a positioned on one end of the rod member 17 is inserted is formed in the counterweight 28. When an impact load which is applied from a lateral side of the vehicle body is inputted, the counterweight 28 transmits an inertia force acting on the counterweight 28 to the rod member 17, as a load in a latch maintaining direction. The counterweight 28 extends, in the front-rear direction (the horizontal direction) of the vehicle body, from the tip end of the second arm 24. The engaging hole 27 is formed in a part of the counterweight 28 so as to extend in an extension direction of the counterweight 28.

In an initial state where the grip 20 is not pulled from the outside, the second arm 24 is disposed to protrude, from a horizontal posture, upward at predetermined angles, as illustrated in FIG. 4. When the grip 20 in the initial state is pulled, and thus a rotational force is transmitted via the first arm 23 to the pivoting block 22, a tip end of the second arm 24 is displaced downward by a predetermined distance, as illustrated by the imaginary line in FIG. 4. Accordingly, the rod member 17 is displaced in the latch releasing direction.

Furthermore, a protrusion 29 is continuously formed over the substantially entire area of the counterweight 28 in the extension direction (a direction parallel to the front-rear direction of the vehicle body). In the initial state described above, the tip end of the protrusion 29 protrudes toward an inner side in a vehicle width direction.

Meanwhile, the sash member 12 which extends in the substantially up-down direction is disposed in a rear edge portion which is located on an inner side of the door body 11, as illustrated in FIGS. 1 and 4. This sash member 12 is constituted by an upper sash 30, a lower sash 31, and a connecting bracket 32, as illustrated in FIG. 4. The upper sash 30 is fixed to an upper portion of the door body 11 such that a lower end of the upper sash 30 is inserted, from an upper side of the door body 11, into the hollow portion of the door body 11. The lower sash 31 is fixed into the hollow portion of the door body 11 so as to be continuous with a lower end of the upper sash 30. The connecting bracket 32 is joined to an upper end of the lower sash 31 and covers a periphery (a periphery except for a groove portion for guiding the door glass 13) of the upper sash 30 with a gap d interposed between the upper sash 30 and the connecting bracket 32. A cross-sectional surface of the connecting bracket 32 has a substantially U shape.

In this case, the counterweight 28 of the door outer handle 14, which extends in the front-rear direction of the vehicle body, is configured such that the counterweight 28 in the initial state directly faces the connecting bracket 32 of the sash member 12, from an outer side in the vehicle width direction. However, a gap, as much as the counterweight 28 does not interfere with the connecting bracket when in a latch releasing operation in a normal operation, is provided between the counterweight 28 and the connecting bracket 32.

The counterweight 28 is configured to come into contact with the connecting bracket 32 when the impact load which is applied from the lateral side of the vehicle body and is described in detail later is inputted. More specifically, the counterweight 28 is configured such that the protrusion 29 thereof comes into contact with a part of the connecting bracket 32, in which the upper sash 30 faces the counterweight 28 with the gap d interposed therebetween.

In the configuration described above, when the impact load is inputted from the outer side in the vehicle width direction to the door body 11 in a state where the door 10 is closed, an inertia force which directs to the outer side in the vehicle width direction acts on the counterweight 28 of the door outer handle 14. Thus, the inertia force acts on the rod member 17 as a load in the latch maintaining direction (a direction in which the engagement between the latch mechanism 16 and striker 15 is maintained), and the door outer handle 14 is displaced in a vehicle interior direction with deformation of the door body 11.

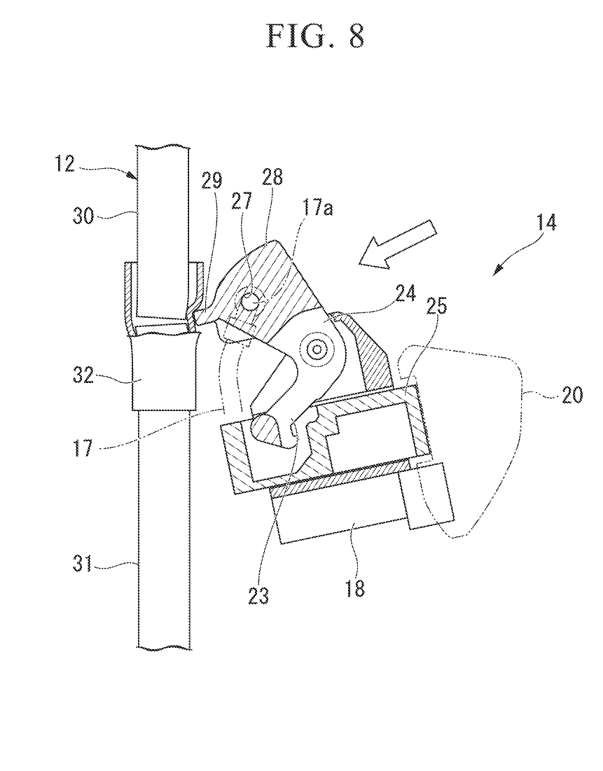

Subsequently, when the door outer handle 14 is displaced in the vehicle interior direction by a distance equal to or greater than the predetermined distance, the protrusion 29 of the counterweight 28 of the door outer handle 14 comes into contact with the connecting bracket 32 of the sash member 12, as shown in FIG. 8 which illustrates the behavior of the door outer handle 14 when the impact load is inputted. Thus, the protrusion 29 causes the sash member 12 to be deformed such that the protrusion 29 cuts into the connecting bracket 32. As a result, the counterweight 28 is firmly engaged with the sash member 12 and the pivoting block 22 of the door outer handle 14 is maintained as a pivoting posture in which the latch mechanism 16 can maintain an engaged state.

Accordingly, the release of the latch mechanism 16 of the door 10 is reliably limited even when the deformation of the door body 11 progresses.

As described above, in the door 10 of the embodiment, the counterweight 28 of the door outer handle 14 is disposed at a position at which the counterweight 28 directly faces the sash member 12, at the outer side of the sash member 12 in the vehicle width direction. Thus, when the impact load applied from the lateral side of the vehicle body is inputted, and thus the door outer handle 14 is deformed in the vehicle interior direction by a distance equal to or greater than the predetermined distance, the counterweight 28 is directly engaged with the sash member 12. Accordingly, the release of the latch mechanism 16 via the rod member 17 can be reliably limited.

Therefore, when the impact load applied from the lateral side of the vehicle body is inputted, the release of the latch mechanism 16 of the door 10 of the embodiment can be reliably limited without causing installation of additional dedicated components or a complicated structure.

Furthermore, in the door 10 of the embodiment, the end portion of the rod member 17 is directly connected to the counterweight 28. Thus, when the impact load applied from the lateral side of the vehicle body is inputted, a displacement of the end of the rod member 17 is limited directly by the counter weight 28 whose displacement is limited by coming into contact with the sash member 12. Accordingly, by employing the door 10, unexpected release of the latch mechanism 16 can be reliably limited when impact is inputted.

Furthermore, the door 10 of the embodiment has a structure in which the counterweight 28 extends, in the front-rear direction (a substantially horizontal direction) of the vehicle body, from the end of the second arm 24 of the pivoting block 22 and wraps, from the outside of the vehicle, a wide area around a front side and a rear side of the sash member 12. Thus, when the impact load applied from the lateral side of the vehicle body is inputted, the counterweight 28 can reliably come into contact with the sash member 12, even when the door outer handle 14 is displaced to shift in the front-rear direction of the vehicle body or the door outer handle 14 is displaced obliquely owing to the deformation of the door body 11.

Furthermore, in the door 10 of the embodiment, the engaging hole 27 is provided in the counterweight 28 of the pivoting block 22 so as to extend in the extension direction of the counterweight 28 and the bent portion 17a which is the end of the rod member 17 is inserted into the engaging hole 27. Thus, a sufficient length of the end the rod member 17 can be stably engaged with the counterweight 28. Accordingly, by employing this structure, the rod member 17 can be stably operated in normal use. In addition, the unexpected release of the latch mechanism 16 can be reliably limited, through the rod member 17, when the impact load is inputted.

In addition, the door 10 of the embodiment is configured such that the protrusion 29 is provided in the counterweight 28 to extend in the sash member 12 direction, and thus, when the impact load is inputted, the protrusion 29 of the counterweight 28 firstly comes into contact with the sash member 12. Accordingly, when the impact load is inputted, the protrusion 29 of the counterweight 28 cuts into the sash member 12, and thus the sash member 12 is easily and reliably deformed. As a result, the engaged state between the counterweight 28 and the sash member 12 can be reliably maintained.

In the door 10 of the embodiment, the connecting bracket 32 is attached to the upper end of the lower sash 31 of the sash member 12 and the gap d is provided between the connecting bracket 32 and the periphery of the upper sash 30. In addition, when the impact load applied from the lateral side of the vehicle body is inputted, the counterweight 28 is configured to come into contact with a part of the connecting bracket 32, which is located outside the gap d between the connecting bracket 32 and the upper sash 30. Accordingly, the sash member 12 can be easily deformed around the connecting bracket 32. Therefore, when the configuration described above is applied, the displacement of the rod member 17 in the latch releasing direction can be more reliably limited.

In the door 10 of the embodiment, when the impact load applied from the lateral side of the vehicle body is inputted, the counterweight 28 comes into contact with the connecting bracket 32 of the sash member 12, which does not directly guide upward and downward movement of the door glass 13. Thus, there is an advantage in that performance for guiding the upward and downward movement of the door glass 13 is not deteriorated in normal use even when the rigidity of the connecting bracket 32 is set to be low, and thus the sash member 12 is more easily deformed when the impact load is inputted.

The preferred embodiment of the invention is described above. However, it should be understood that the embodiment described above is exemplary and is not intended to limit the invention. Addition, omission, substitution, and other modification can be performed insofar as it does not depart from the scope of the invention. Thus, it should be considered that the invention is not limited by the description described above but limited by the appended claims.

### REFERENCE SIGNS LIST

2: door opening

10: door (vehicle door)

11: door body

12: sash member

13: door glass

14: door outer handle

15: striker (engaging member)

16: latch mechanism

17: rod member

18: base block

20: grip

21: pivot shaft

22: pivoting block

23: first arm (lever portion)

24: second arm (lever portion)

28: counterweight

29: protrusion

30: upper sash

31: lower sash

32: connecting bracket

1. A vehicle door that opens or closes a door opening of a vehicle body, comprising:
a door body inside which a hollow portion is formed;
a door glass that is upward and downward movably held to an upper portion of the door body;
a sash member that is disposed in the hollow portion of the door body and guides upward and downward movement of the door glass;
a door outer handle that has a grip to be gripped by an operator of a door, is provided on a vehicle outer side surface of the door body, and is operable to move forward or rearward;
a latch mechanism that is installed on the door body and is engaged with an engaging member, the engaging member being positioned on a vehicle body when the door is closed;
a rod member that connects the door outer handle and the latch mechanism such that the door outer handle operates simultaneously with the latch mechanism; and
a counterweight that is provided in the door outer handle and is disposed at a position at which the counterweight directly faces the sash member with a gap interposed between the counterweight and the sash member, at an outer side of the sash member in an in-out direction of the vehicle, and the counterweight transmitting an inertia force of the counterweight, which acts when an impact load applied from outside of the vehicle is inputted, to the rod member as a load in a latch maintaining direction.

2. The vehicle door according to claim 1, wherein
the rod member is directly connected to the counterweight.

3. The vehicle door according to claim 2, wherein
the door outer handle further includes a base block which is fixed to the door body and a lever portion which is pivotally supported to the base block by a pivot shaft which extends in a direction perpendicular to the in-out direction of the vehicle, wherein
the lever portion has a first arm and a second arm which are arranged to sandwich the pivot shaft, in which the grip is engaged with the first arm such that the grip operates simultaneously with the first arm, and the rod member is engaged with the second arm such that the rod member operates simultaneously with the second arm, and wherein
the counterweight extends from the second arm in a substantially horizontal direction.

4. The vehicle door according to claim 3, wherein
an end of the rod member is inserted into the counterweight, along an extension direction of the counterweight.

5. The vehicle door according to claim 1, wherein
the counterweight includes a protrusion which extends in a direction in which the protrusion faces the sash member.

6. The vehicle door according to claim 1, wherein
the sash member includes:
an upper sash having a lower end, the lower end being disposed in the hollow portion of the door body;
a lower sash that is separated from the upper sash and disposed in the hollow portion of the door body so as to be continuous with the upper sash; and
a connecting bracket that is installed on an upper end of the lower sash and covers a periphery of the upper sash with a gap interposed between the upper sash and the connecting bracket, and
the counterweight comes into contact with the connecting bracket when the impact load applied from outside of the vehicle is inputted.
